(19) United States
(12) Patent Application Publication
(10) Pub. No.: US 2015/0262542 A1
(43) Pub. Date: Sep. 17, 2015

(54) PIXEL CIRCUIT OF LIQUID CRYSTAL DISPLAY AND CONTROL METHOD THEREOF

(71) Applicant: AU Optronics Corp., Hsin-Chu (TW)

(72) Inventors: Chih-Lung Lin, Hsin-Chu (TW); Chun-Da Tu, Hsin-Chu (TW); Mao-Hsun Cheng, Hsin-Chu (TW); Ching-Huan Lin, Hsin-Chu (TW); Kun-Ying Hsin, Hsin-Chu (TW)

(21) Appl. No.: 14/527,764

(22) Filed: Oct. 29, 2014

(30) Foreign Application Priority Data
Mar. 12, 2014 (TW) 103108739

(51) Int. Cl. G09G 3/36

(52) U.S. Cl. CPC G09G 3/3696; G09G 2300/0847; G09G 2330/04; G09G 2330/02

(57) ABSTRACT

A pixel circuit of a liquid crystal display (LCD) has a first switch, a second switch, a third switch, a storage capacitor and a liquid crystal capacitor. The first switch controls electrical connection between a data line and the storage capacitor according to a voltage level of a first gate line. The second switch controls electrical connection between the storage capacitor and the liquid crystal capacitor according to a voltage level of a second gate line. The third switch controls electrical connection between a bias line and the liquid crystal capacitor according to the voltage level of the first gate line. Within each frame period of the LCD, the second switch is turned off while the first switch and the third switch are turned on, and the first switch and the third switch are turned off while the second switch is turned on.

### BACKGROUND OF THE INVENTION

1. Field of the Invention

The present invention is related to a pixel circuit of a liquid crystal display (LCD) and control method thereof, and more particularly to a pixel circuit of a LCD and control method thereof capable of speedy charging pixels of the LCD.

2. Description of the Prior Art

Liquid crystal displays (LCDs) have developed many years. In early stages of LCDs, the manufacturers of LCDs focused on reducing the weight and the size of LCDs, such that LCDs have replaced cathode ray tube (CRT) displays that are heavy and big. In recent years, customers pursue high-quality entertainments and effects of video and audio, such that the manufacturers of LCDs recently focus on developments of high resolution and high dimension televisions to stratify the expectancy of the customers. Since the response speed of blue phase liquid crystal (BPLC) is ten times faster than that of conventional liquid crystal, BPLC displays are regarded as the next generation high-end displays. However, because an equivalent capacitance of BPLC is greater than that of conventional liquid crystal, a conventional 1T2C (one transistor and two capacitors) pixel circuit is not capable of speedy charging BPLC to a desired gray-level voltage anymore. Moreover, as compared to the conventional liquid crystal, BPLC needs a higher operational voltage to achieve greater transmittance.

Please refer to FIG. 1. FIG. 1 is a circuit diagram of a pixel circuit 100 of an LCD according to the prior art. The pixel circuit adopts a structure of 1T2C and has a switch T_{A}, a storage capacitor C_{ST} and a liquid crystal capacitor C_{LC}, where the switch T_{A} is a transistor. A control terminal of the switch T_{A} turns on/off the switch T_{A} according to a voltage level of a gate line G_{N}. When the switch T_{A} is turned on, a data voltage V_{DATA} of a data line of the LCD is applied to the storage capacitor C_{ST} and the liquid crystal capacitor C_{LC} to charge the storage capacitor C_{ST} and the liquid crystal capacitor C_{LC}, such that a gray-level voltage of the pixel circuit 100 is refreshed. However, since the capacitance of the storage capacitor C_{ST} and the liquid crystal capacitor C_{LC} of blue phase liquid crystal is several times of that of conventional LCD liquid crystal, the pixel circuit 100 having the 1T2C structure is not capable of speedy charging the storage capacitor C_{ST} and the liquid crystal capacitor C_{LC} of blue phase liquid crystal to desired gray-level voltages.

### SUMMARY OF THE INVENTION

An embodiment of the present invention provides a pixel circuit of a liquid crystal display. The pixel circuit comprises a first switch, a second switch, a third switch, a storage capacitor and a liquid crystal capacitor. The first switch has a first terminal, a second terminal and a control terminal, the first terminal is configured to receive a data voltage, and the control terminal is coupled to a first gate line. The second switch has a first terminal, a second terminal and a control terminal. The first terminal of the second switch is coupled to the second terminal of the first switch, and the control terminal of the second switch is coupled to a second gate line. The third switch has a first terminal, a second terminal and a control terminal. The first terminal of the third switch is coupled to the second terminal of the second switch, the second terminal of the third switch is configured to receive a bias voltage, and the control terminal of the third switch is coupled to the first gate line. The storage capacitor has a first end and a second end. The first end of the storage capacitor is coupled to the second terminal of the first switch and the first terminal of the second switch. The liquid crystal capacitor has a first end and a second end. The first end of the liquid crystal capacitor is coupled to the second terminal of the second switch and the first terminal of the third switch, and the second end of the liquid crystal capacitor is coupled to a common electrode. The second switch is turned off while the first switch and the third switch are turned on within each frame period of the liquid crystal display. The second switch is turned on while the first switch and the third switch are turned off within each frame period of the liquid crystal display.

An embodiment of the present invention provides a method for controlling a pixel circuit of a liquid crystal display. The pixel circuit comprises a first switch, a second switch, a third switch, a storage capacitor and a liquid crystal capacitor. A first terminal of the first switch is configured to receive a data voltage, a second terminal of the first switch is coupled to a first terminal of the second switch and a first end of the storage capacitor, and a control terminal of the first switch is coupled to a first gate line. A second terminal of the second switch is coupled to a first terminal of the third switch and a first end of the liquid crystal capacitor, and a control terminal of the second switch is coupled to a second gate line. A second terminal of the third switch is configured to receive a bias voltage, a control terminal of the third switch is coupled to the first gate line, and a second end of the liquid crystal capacitor is coupled to a common electrode. The method comprises turning off the second switch while the first switch and the third switch are turned on within each frame period of the liquid crystal display; and turning on the second switch while the first switch and the third switch are turned on within each frame period on the liquid crystal display.

According to the embodiments of the present invention, the display data of any pixel may be refreshed within each frame period, and each frame period may be divided into two durations. Within a first one of the two durations, the storage capacitor and the liquid crystal capacitor of the pixel circuit are electrically disconnected and charged separately. Within a second one of the two durations, the electric connection between the storage capacitor and the liquid crystal capacitor is established, such that the storage capacitor and the liquid crystal capacitor share charge to each other. Accordingly, voltage levels of the storage capacitor and the liquid crystal capacitor could be refreshed to desired gray-level voltages in a very short time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a pixel circuit of an LCD according to the prior art.

FIG. 2 is a circuit diagram of a pixel circuit of a liquid crystal display (LCD) according to an embodiment of the present invention.

FIG. 3 is a timing diagram of the pixel circuit in FIG. 2.

FIG. 4 is a waveform diagram showing voltage levels of the pixel when the pixel circuits in FIGS. 1 and 2 respectively drive the storage capacitor CST and the liquid crystal capacitor CLC that have the same capacitance.

FIGS. 5-7 respectively illustrate waveforms of the voltage levels V1 and V2 obtained by computer aided simulations when the pixel circuit in FIG. 2 is simulated by using various combinations of the data voltage and the bias voltage while a second end of the storage capacitor is grounded.

FIGS. 8-10 respectively illustrate waveforms of the voltage levels V1 and V2 obtained by computer aided simulations when the pixel circuit in FIG. 2 is simulated by using various combinations of the data voltage and the bias voltage while a second end of the storage capacitor is coupled to the common electrode.

### DETAILED DESCRIPTION

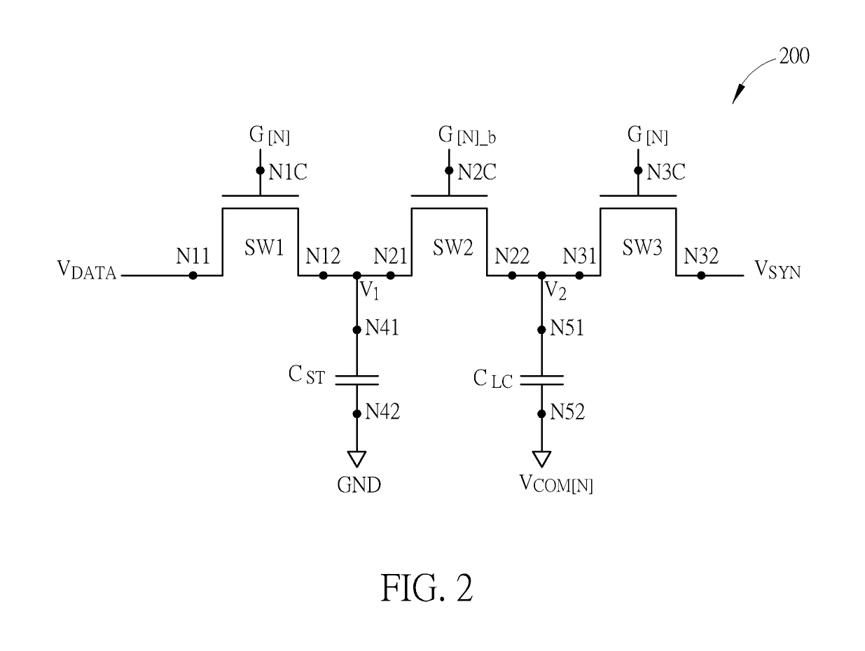

Please refer to FIG. 2. FIG. 2 is a circuit diagram of a pixel circuit 200 of a liquid crystal display (LCD) according to an embodiment of the present invention. The pixel circuit 200 adopts a structure of 3T2C (three transistors and two capacitors) and has a first switch SW1, a second switch SW2, a third switch SW3, a storage capacitor C_{ST} and a liquid crystal capacitor C_{LC}. In the embodiment, each of the first switch SW1, the second switch SW2 and the third switch SW3 is a transistor.

A first terminal N11 of the first switch SW1 receive a data voltage V_{DATA} from a data line of the LCD, a second terminal of the first switch SW2 is coupled to a first terminal N21 of the first switch SW2 and a first end N41 of the storage capacitor C_{ST}, and a control terminal N1C of the first switch SW1 is coupled to a first gate line G_{[N]}. A second terminal N22 of the second switch SW2 is coupled to a first terminal N31 of the third switch SW3 and a first end N51 of the liquid crystal capacitor C_{LC}, and a control terminal N2C of the second switch SW2 is coupled to a second gate line G_{[N]}_{_{—}}_{b}. A second terminal N32 of the third switch SW3 receives a bias voltage V_{SYN}, and a control terminal N3C of the third switch SW3 is coupled to the first gate line G_{[N]}. In the embodiment, a second end N52 of the liquid crystal capacitor C_{LC} is coupled to a common electrode V_{COM [N]}, and a second end N42 of the storage capacitor C_{ST} is coupled to a grounded end GND. In another embodiment of the present invention, both of the second end N42 of the storage capacitor C_{ST} and the second end of the liquid crystal capacitor C_{LC} are coupled to the common electrode V_{COM[N]}.

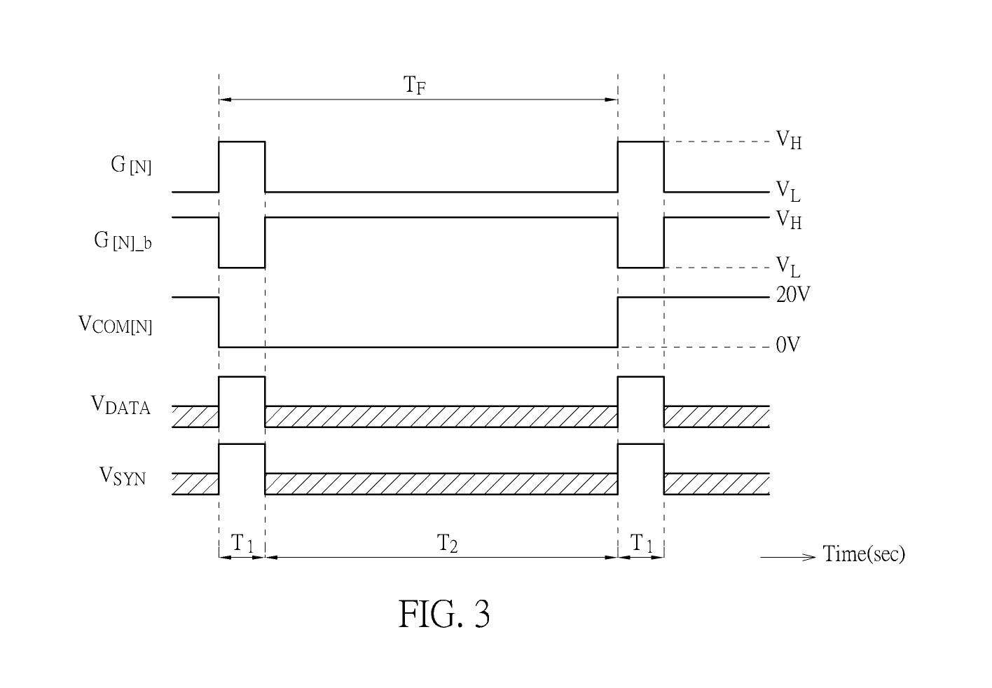

The first switch SW1 and the third switch SW3 are turn on/off according to a voltage level of the first gate line G_{[N]}, and the second switch SW2 is turned on/off according to a voltage level of the second gate line G_{[N]}_{_{—}}_{b}. Please refer to FIG. 3 with reference of FIG. 2. FIG. 3 is a timing diagram of the pixel circuit 200 in FIG. 2. Each of frame periods of the LCD is divided into a first duration T₁ and a second duration T₂. Within the first duration T₁, the voltage level of the first gate line G_{[N]} is equal to a first voltage level V_{H}, and the voltage level of the second gate line G_{[N]}_{_{—}}_{b} is equal to a second voltage level V_{L}, such that the first switch SW1 and the third switch SW3 are turn on, and the second switch SW2 is turned off. Wherein the first voltage level V_{H} is greater than the second voltage level V_{L}. Within the second duration T₂, the voltage level of the first gate line G_{[N]} is equal to the second voltage level V_{L}, and the voltage level of the second gate line G_{[N]}_{_{—}}_{b} is equal to the first voltage level V_{H}, such that the second switch SW2 is turned on, and the first switch SW1 and the third switch SW3 are turn off. Moreover, a voltage level of the common electrode V_{COM[N]} is switched once between two voltage levels within each frame period T_{F} of the LCD, such that polarity inversions of the pixels of the LCD are performed. As shown in FIG. 3, in the embodiment, the voltage level of the common electrode V_{COM[N]} is switched once between 20 volts and zero volts within each frame period T_{F}. However, the present invention is not limited thereto. It could be understood by one skilled in the art that the voltage level of the common electrode V_{COM[N]} could be switched between other voltages.

By switching the voltage levels of the first gate line G_{[N]} and the second gate line G_{[N]}_{_{—}}_{b}, the storage capacitor C_{ST} and the liquid crystal capacitor C_{LC} are electrically disconnected and respectively charged by the data voltage V_{DATA} and the bias voltage V_{SYN} within the first duration T₁ since the first switch SW1 and the third switch SW3 are turned on. Therefore, within the first duration T₁, the data voltage V_{DATA} only charges the storage capacitor C_{ST}, and the bias voltage V_{SYN} only charges the liquid crystal capacitor C_{LC}. Since the storage capacitor C_{ST} and the liquid crystal capacitor C_{LC} are respectively charged by the data voltage V_{DATA} and the bias voltage V_{SYN}, the speed of charging the pixel circuit 200 is greater than that of the pixel circuit 100 of the prior art that charges both of the storage capacitor C_{ST} and the liquid crystal capacitor C_{LC} with the data voltage V_{DATA}. Therefore, the charging time could be shorten by separately charging the storage capacitor C_{ST} and the liquid crystal capacitor C_{LC}, such that the gray-level of the pixel could be refreshed in a very short time.

Moreover, within the second duration T₂, the storage capacitor C_{ST} and the liquid crystal capacitor C_{LC} of the pixel circuit 200 are electrically connected since the second switch SW2 is turned on, and the storage capacitor C_{ST} and the liquid crystal capacitor C_{LC} are not charged by the data voltage V_{DATA} and the bias voltage V_{SYN} since the first switch SW1 and the third switch SW3 are turned off. Since the storage capacitor C_{ST} and the liquid crystal capacitor C_{LC} are electrically connected within the second duration T₂, the storage capacitor C_{ST} and the liquid crystal capacitor C_{LC} share charge to each other, such that a voltage level V₁ of the first end N41 of the storage capacitor C_{ST} is equal to a voltage level V₂ of the first end N51 of the liquid crystal capacitor C_{LC}. In this case the voltage levels V₁ and V₂ may be represented as following:

$${V}_{1} = {V}_{2} = {V}_{DATA} ( \frac{{C}_{ST}}{{C}_{ST} + {C}_{LC}} ) + {V}_{SYN} ( \frac{{C}_{LC}}{{C}_{ST} + {C}_{LC}} )$$

Moreover, if the capacitance of the storage capacitor C_{ST} is equal to the capacitance of the liquid crystal capacitor C_{LC}, then

$${V}_{1} = {V}_{2} = {V}_{DATA} = \frac{1}{2} {V}_{DATA} + \frac{1}{2} {V}_{SYN}$$

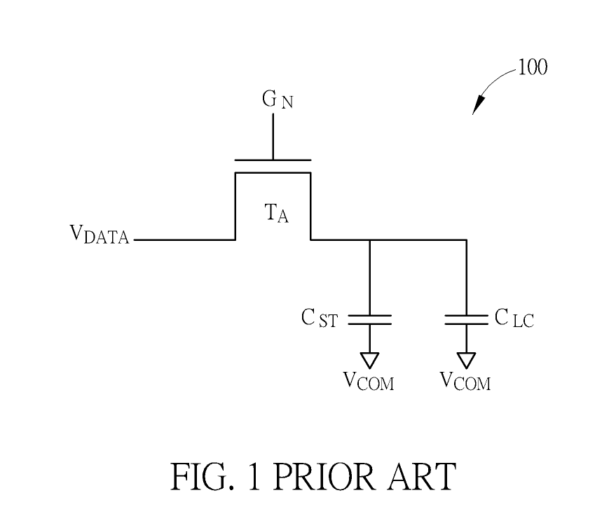

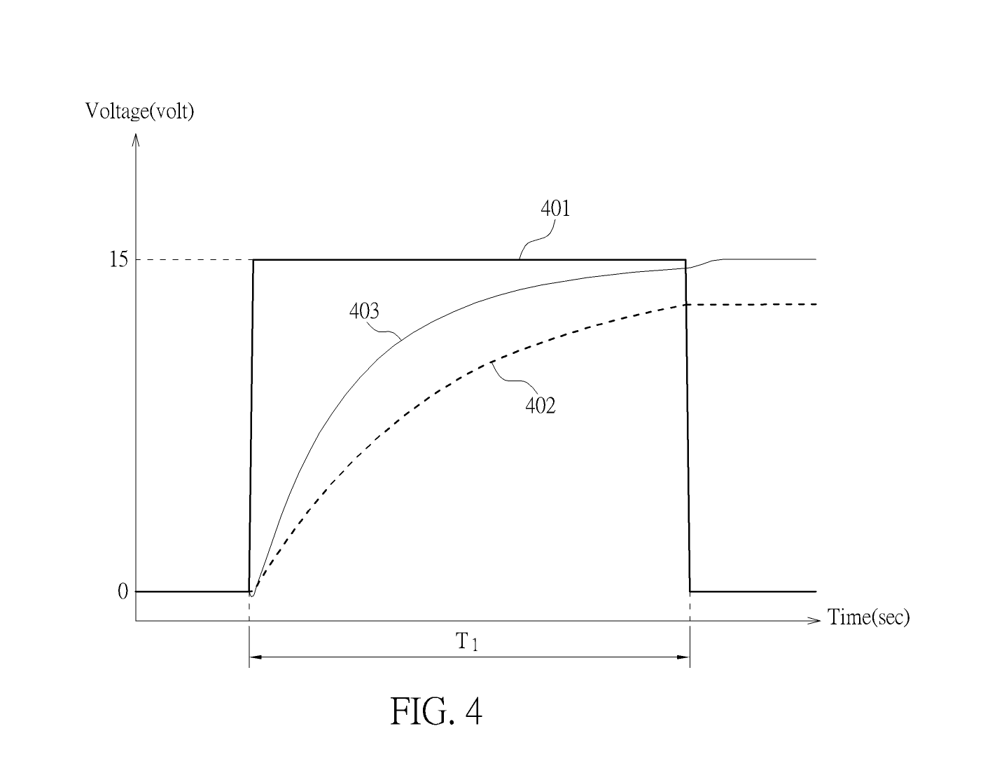

According to the above equations, the gray-level voltage of the pixel may be reached to the desired voltage level by controlling the data voltage V_{DATA} and the bias voltage V_{SYN}. Please refer to FIG. 4. FIG. 4 is a waveform diagram showing voltage levels of the pixel when the pixel circuit 200 in FIG. 2 and the pixel circuit 100 in FIG. 1 respectively drive the storage capacitor C_{ST} and the liquid crystal capacitor C_{LC} that have the same capacitance. Wherein, a curve 401 represents the waveform of the data voltage V_{DATA}, a curve 402 represents the waveform of a connection point of the storage capacitor C_{ST} and the liquid crystal capacitor C_{LC} of the switch T_{A} of the pixel circuit 100, and a curve 403 represents the waveform of the voltage level V₁ of the pixel circuit 200. If the capacitance of the storage capacitor C_{ST} of the pixel circuits 100 and 200 is 10 picofarads (pF), and the capacitance of the liquid crystal capacitor C_{LC} of the pixel circuits 100 and 200 is also 10 picofarads (pF), the speed of charging the pixel circuit 200 is greater than that of the pixel circuit 100, as shown in FIG. 4.

Please refer to FIG. 2 again. In order to improve the efficiency of the pixel circuit 200 to refresh the gray-level voltage of the pixel to the desired voltage, in an embodiment of the present invention, the bias voltage V_{SYN} could be switched among a plurality of voltage levels according to a voltage level of the data voltage V_{DATA}. For example, the bias voltage V_{SYN} may be switched among 25 volts, 10 volts and 0 volts. However, the present invention is not limited thereto. The bias voltage V_{SYN} may be switched among other voltage levels. In detail, when the voltage level of the data voltage V_{DATA} is a high voltage level, the bias voltage V_{SYN} may be high; and when the voltage level of the data voltage V_{DATA} is a low voltage level, the bias voltage V_{SYN} may be low. For example, when the data voltage V_{DATA} has a high voltage level while the gray-level of the pixel is equal to the maximum gray-level 255, the voltage level of the bias voltage V_{SYN} may be 25 volts. When the gray-level of the pixel is equal to 125, the voltage level of the bias voltage V_{SYN} may be 10 volts. When the voltage level of the data voltage V_{DATA} is zero volts while the gray-level of the pixel is equal to the minimum gray-level 0, the voltage level of the bias voltage V_{SYN} may be zero volts.

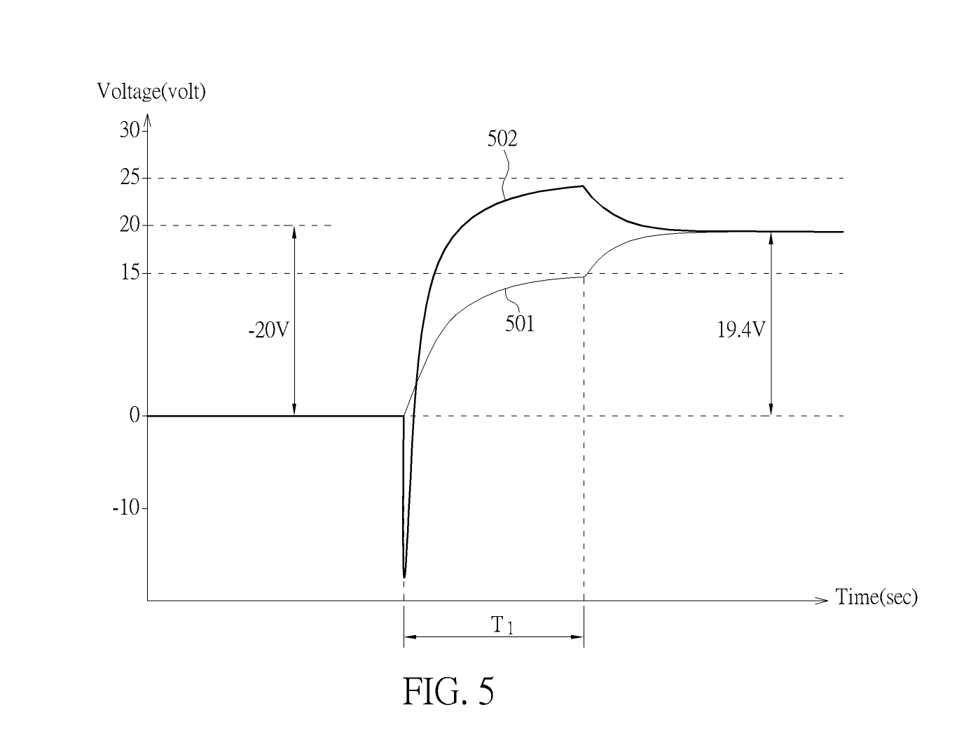

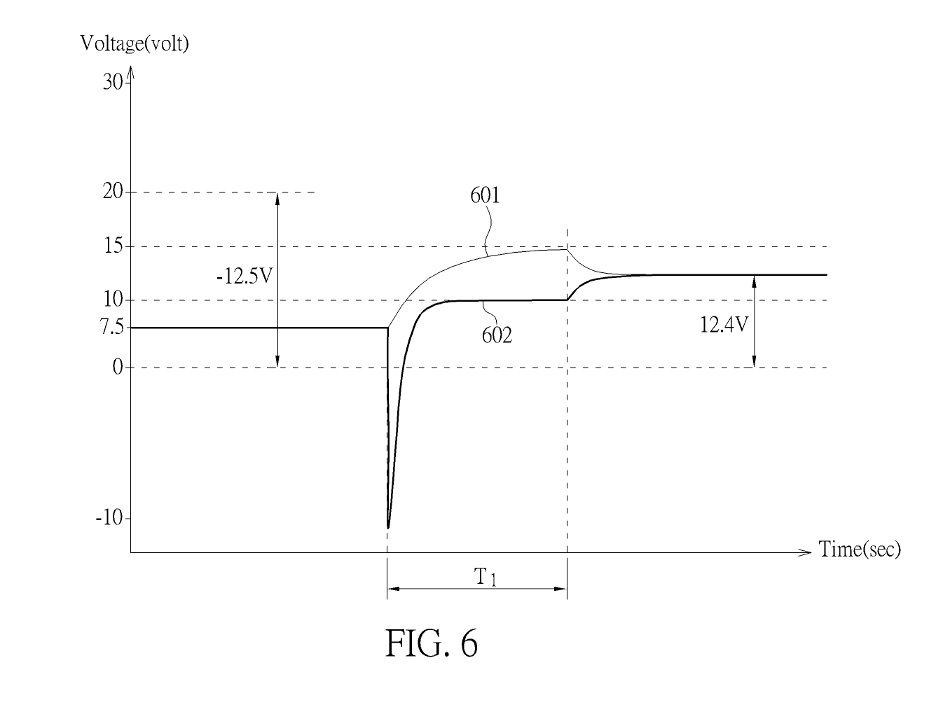

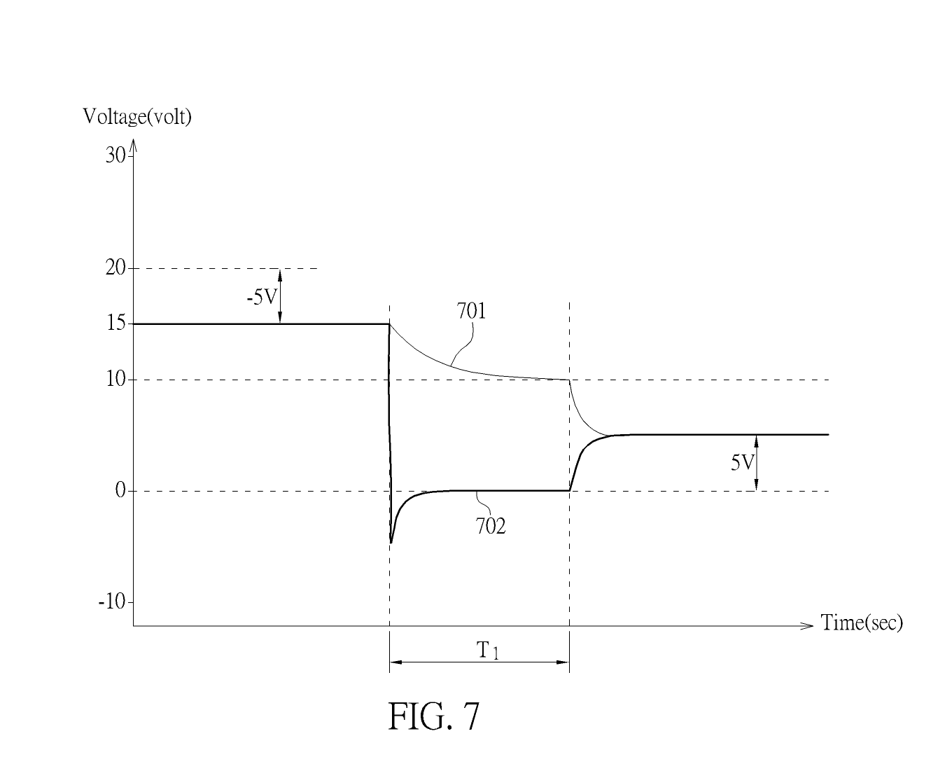

Please refer to FIG. 5 to FIG. 7 with reference of FIG. 2. FIGS. 5-7 respectively illustrate waveforms of the voltage levels V₁ and V₂ obtained by computer aided simulations when the pixel circuit 200 is simulated by using various combinations of the data voltage V_{DATA} and the bias voltage V_{SYN} while the second end N42 is grounded. During these simulations, the capacitance of the storage capacitor C_{ST} and the capacitance of the liquid crystal capacitor C_{LC} are both 10 picofarads (pF), and the voltage levels of the first gate line G_{[N]} and the second gate line G_{[N]}_{_{—}}_{b} are respectively switched between 30 volts and −10 volts. Within the first duration T₁, the voltage level of the first gate line G_{[N]} is 30 volts, and the voltage level of the second gate line G_{[N]}_{_{—}}_{b} is −10 volts. Moreover, the voltage level of the common electrode V_{COM[N]} is switched between 20 volts and zero volts. Curves 501 and 502 in FIG. 5 are the waveforms of the voltage levels V₁ and V₂ obtained through the simulations. The voltage levels of the data voltage V_{DATA} and the bias voltage V_{SYN} within the first duration T₁ are 15 volts and 25 volts respectively. As shown in FIG. 5, before the first duration T₁ passes, the voltage difference between the common electrode V_{COM[N]} and the voltage levels V₁ and V₂ is −20 volts. After the first duration T₁ passes, due to the polarity inversion of the pixel, the voltage difference between the common electrode V_{COM[N]} and the voltage levels V₁ and V₂ is 19.4 volts. Curves 601 and 602 in FIG. 6 are the waveforms of the voltage levels V₁ and V₂ obtained through the simulations with different parameters. The voltage levels of the data voltage V_{DATA} and the bias voltage V_{SYN} within the first duration T₁ are 15 volts and 10 volts respectively. As shown in FIG. 6, before the first duration T₁ passes, the voltage difference between the common electrode V_{COM[N]} and the voltage levels V₁ and V₂ is 12.5 volts. After the first duration T₁ passes, due to the polarity inversion of the pixel, the voltage difference between the common electrode V_{COM[N]} and the voltage levels V₁ and V₂ is 12.4 volts. Curves 701 and 702 in FIG. 7 are the waveforms of the voltage levels V₁ and V₂ obtained through the simulations with different parameters. The voltage levels of the data voltage V_{DATA} and the bias voltage V_{SYN} within the first duration T₁ are 10 volts and zero volts respectively. As shown in FIG. 7, before the first duration T₁ passes, the voltage difference between the common electrode V_{COM[N]} and the voltage levels V₁ and V₂ is 5 volts. After the first duration T₁ passes, due to the polarity inversion of the pixel, the voltage difference between the common electrode V_{COM[N]} and the voltage levels V₁ and V₂ is 5 volts. Therefore, according to the results of the simulations in FIGS. 5-7, after the polarity inversion of the pixel is performed, the voltage difference between the common electrode V_{COM[N]} and the voltage levels V₁ and V₂ is almost maintained, such that the pixel stably displays a corresponding gray-level.

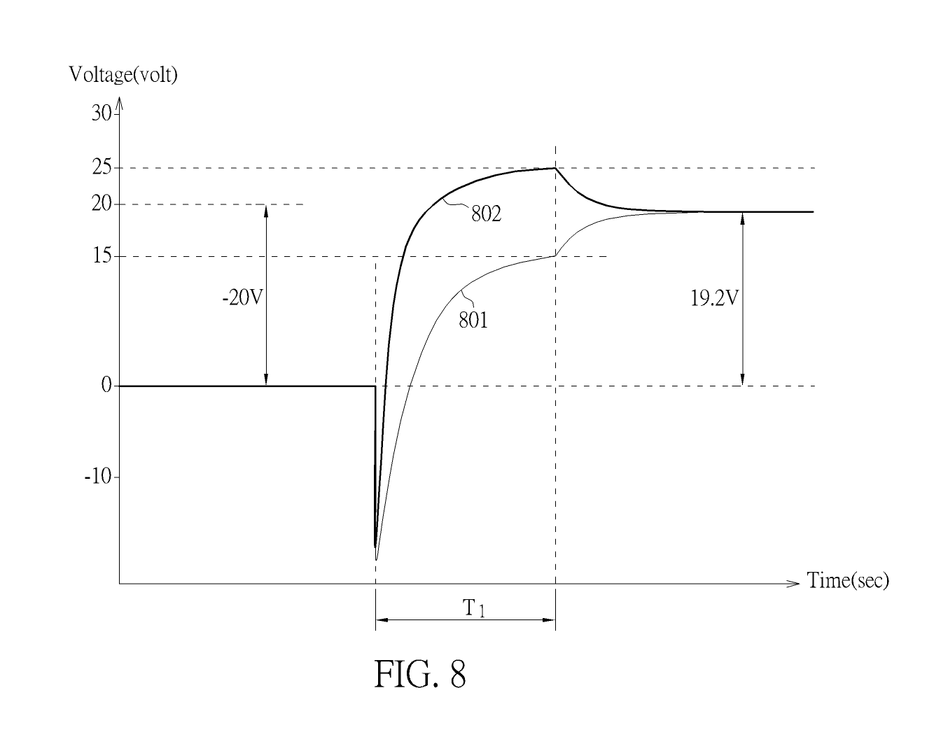

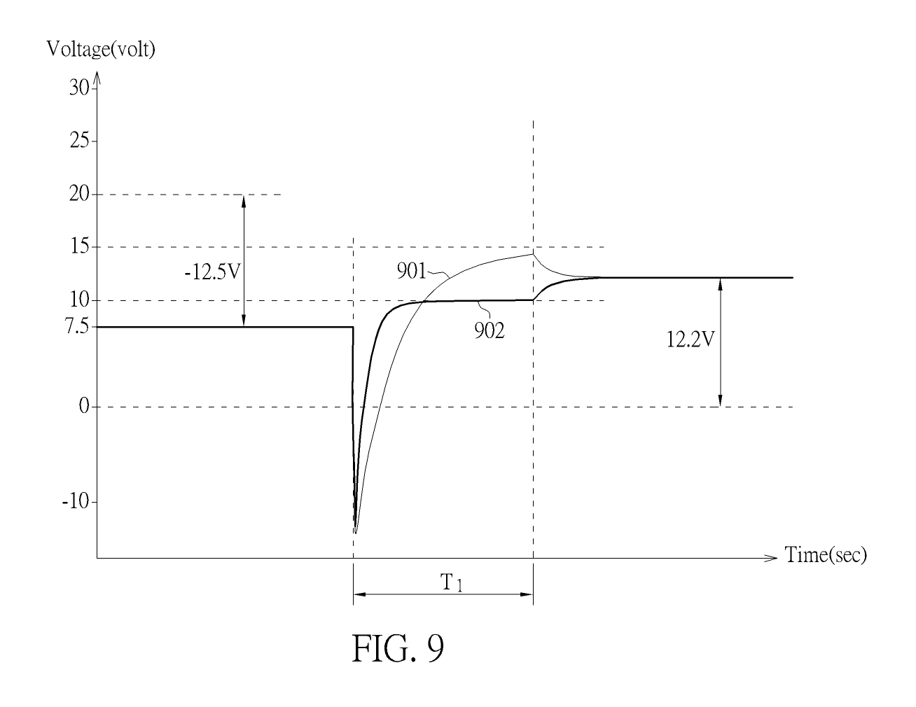

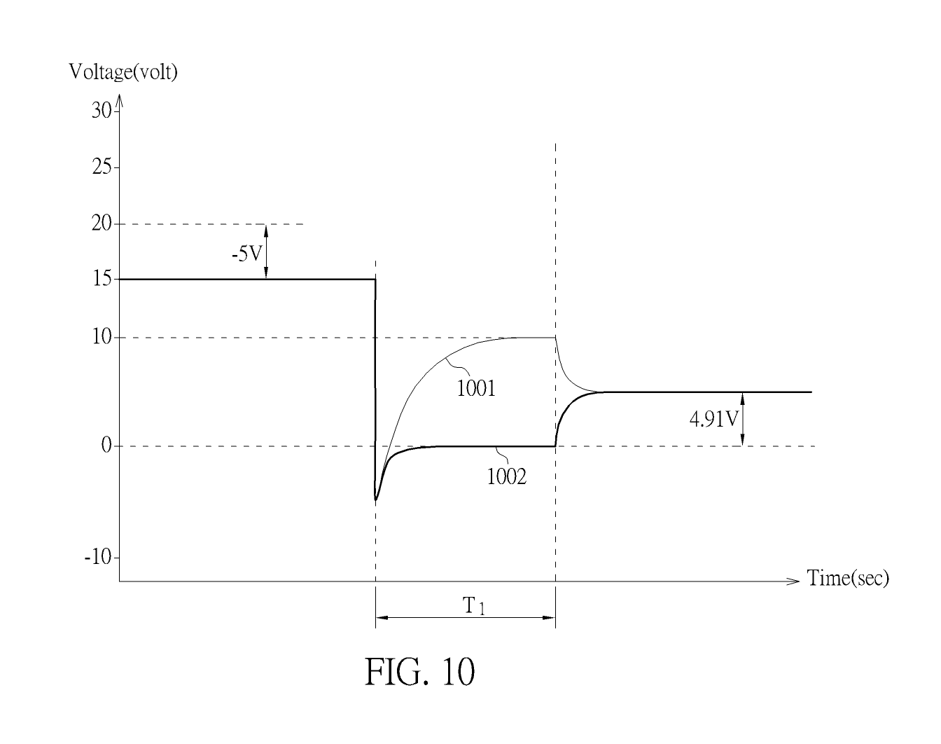

Please refer to FIG. 8 to FIG. 10 with reference of FIG. 2. FIGS. 8-10 respectively illustrate waveforms of the voltage levels V₁ and V₂ obtained by computer aided simulations when the pixel circuit 200 is simulated by using various combinations of the data voltage V_{DATA} and the bias voltage V_{SYN} while the second end N42 is coupled to the common electrode VCOM_{[N]}. During these simulations, the capacitance of the storage capacitor C_{ST} and the capacitance of the liquid crystal capacitor C_{LC} are both 10 picofarads (pF), and the voltage levels of the first gate line G_{[N]} and the second gate line G_{[N]}_{_{—}}_{b} are respectively switched between 30 volts and −10 volts. Within the first duration T₁, the voltage level of the first gate line G_{[N]} is 30 volts, and the voltage level of the second gate line G_{[N]}_{_{—}}_{b} is −10 volts. Moreover, the voltage level of the common electrode V_{COM[N]} is switched between 20 volts and zero volts. Curves 801 and 802 in FIG. 8 are the waveforms of the voltage levels V₁ and V₂ obtained through the simulations. The voltage levels of the data voltage V_{DATA} and the bias voltage V_{SYN} within the first duration T₁ are 15 volts and 25 volts respectively. As shown in FIG. 8, before the first duration T₁ passes, the voltage difference between the common electrode V_{COM[N]} and the voltage levels V₁ and V₂ is −20 volts. After the first duration T₁ passes, due to the polarity inversion of the pixel, the voltage difference between the common electrode V_{COM[N]} and the voltage levels V₁ and V₂ is 19.2 volts. Curves 901 and 902 in FIG. 9 are the waveforms of the voltage levels V₁ and V₂ obtained through the simulations with different parameters. The voltage levels of the data voltage V_{DATA} and the bias voltage V_{SYN} within the first duration T₁ are 15 volts and 10 volts respectively. As shown in FIG. 9, before the first duration T₁ passes, the voltage difference between the common electrode V_{COM[N]} and the voltage levels V₁ and V₂ is 12.5 volts. After the first duration T₁ passes, due to the polarity inversion of the pixel, the voltage difference between the common electrode V_{COM[N]} and the voltage levels V₁ and V₂ is 12.2 volts. Curves 1001 and 1002 in FIG. 10 are the waveforms of the voltage levels V₁ and V₂ obtained through the simulations with different parameters. The voltage levels of the data voltage V_{DATA} and the bias voltage V_{SYN} within the first duration T₁ are 10 volts and zero volts respectively. As shown in FIG. 10, before the first duration T₁ passes, the voltage difference between the common electrode V_{COM[N]} and the voltage levels V₁ and V₂ is 5 volts. After the first duration T₁ passes, due to the polarity inversion of the pixel, the voltage difference between the common electrode V_{COM[N]} and the voltage levels V₁ and V₂ is 4.91 volts. Therefore, according to the results of the simulations in FIGS. 8-10, after the polarity inversion of the pixel is performed, the voltage difference between the common electrode V_{COM[N]} and the voltage levels V₁ and V₂ is almost maintained, such that the pixel stably displays a corresponding gray-level.

Please refer to FIG. 3 again. In foresaid embodiments, the rising edge of a voltage signal of the first gate line G_{[N]} is aligned with the falling edge of a voltage signal of the second gate line G_{[N]}_{_{—}}_{b} in timing, and the falling edge of a voltage signal of the first gate line G_{[N]} is aligned with the rising edge of a voltage signal of the second gate line G_{[N]}_{_{—}}_{b} in timing. However, the present invention is not limited thereto. For example, within each frame period T_{F}, a third duration may be inserted between the first duration T₁ and the second duration T₂. The voltage levels of the first gate line G_{[N]} and the second gate line G_{[N]}_{_{—}}_{b} are equal to the second voltage level V_{L} within the third duration, such that the first switch SW1, the second switch SW2 and the third switch SW3 are turned off within the third duration. Then, within the first duration T₁, the first switch SW1 and the third switch SW3 are turned on, and the second switch SW2 is turned off. Within the second duration T₂, the second switch SW2 is turned on, and the first switch SW1 and the third switch SW3 are turned off.

In summary, according to the embodiments of the present invention, the display data of any pixel may be refreshed within each frame period, and each frame period may be divided into two durations. Within a first one of the two durations, the storage capacitor and the liquid crystal capacitor of the pixel circuit are electrically disconnected and charged separately. Within a second one of the two durations, the electric connection between the storage capacitor and the liquid crystal capacitor is established, such that the storage capacitor and the liquid crystal capacitor share charge to each other. Accordingly, voltage levels of the storage capacitor and the liquid crystal capacitor could be refreshed to desired gray-level voltages in a very short time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pixel circuit of a liquid crystal display, the pixel circuit comprising:
a first switch, having a first terminal, a second terminal and a control terminal, the first terminal being configured to receive a data voltage, and the control terminal being coupled to a first gate line;
a second switch, having a first terminal, a second terminal and a control terminal, the first terminal of the second switch being coupled to the second terminal of the first switch, and the control terminal of the second switch being coupled to a second gate line;
a third switch, having a first terminal, a second terminal and a control terminal, the first terminal of the third switch being coupled to the second terminal of the second switch, the second terminal of the third switch being configured to receive a bias voltage, and the control terminal of the third switch being coupled to the first gate line;
a storage capacitor, having a first end and a second end, the first end of the storage capacitor being coupled to the second terminal of the first switch and the first terminal of the second switch; and
a liquid crystal capacitor, having a first end and a second end, the first end of the liquid crystal capacitor being coupled to the second terminal of the second switch and the first terminal of the third switch, and the second end of the liquid crystal capacitor being coupled to a common electrode;
wherein the second switch is turned off while the first switch and the third switch are turned on within each frame period of the liquid crystal display; and
wherein the second switch is turned on while the first switch and the third switch are turned off within each frame period of the liquid crystal display.

2. The pixel circuit of claim 1, wherein a voltage level of the common electrode is switched once between two voltage levels within each frame period of the liquid crystal display.

3. The pixel circuit of claim 1, wherein when a voltage level of the first gate line is equal to a first voltage level, a voltage level of the second gate line is equal to a second voltage level, the first voltage level is greater than the second voltage level; and
Wherein when the voltage level of the second gate line is equal to the first voltage level, the voltage level of the first gate line is equal to the second voltage level.

4. The pixel circuit of claim 1, wherein the bias voltage is switched among a plurality of voltage levels according to a voltage level of the data voltage.

5. The pixel circuit of claim 4, wherein when the voltage level of the data voltage is equal to zero volts, the bias voltage is equal to zero volts.

6. A method for controlling a pixel circuit of a liquid crystal display, the pixel circuit comprising a first switch, a second switch, a third switch, a storage capacitor and a liquid crystal capacitor, a first terminal of the first switch being configured to receive a data voltage, a second terminal of the first switch being coupled to a first terminal of the second switch and a first end of the storage capacitor, a control terminal of the first switch being coupled to a first gate line, a second terminal of the second switch being coupled to a first terminal of the third switch and a first end of the liquid crystal capacitor, a control terminal of the second switch being coupled to a second gate line, a second terminal of the third switch being configured to receive a bias voltage, a control terminal of the third switch being coupled to the first gate line, and a second end of the liquid crystal capacitor being coupled to a common electrode, the method comprising:
turning off the second switch while the first switch and the third switch are turned on within each frame period of the liquid crystal display; and
turning on the second switch while the first switch and the third switch are turned on within each frame period on the liquid crystal display.

7. The method of claim 6 further comprising:
switching a voltage level of the common electrode once between two voltage levels within each frame period of the liquid crystal display.

8. The method of claim 6, wherein when a voltage level of the first gate line is equal to a first voltage level, a voltage level of the second gate line is equal to a second voltage level, the first voltage level is greater than the second voltage level; and
Wherein when the voltage level of the second gate line is equal to the first voltage level, the voltage level of the first gate line is equal to the second voltage level.

9. The method of claim 6, wherein the bias voltage is switched among a plurality of voltage levels according to a voltage level of the data voltage.

10. The method of claim 9, wherein when the voltage level of the data voltage is equal to zero volts, the bias voltage is equal to zero volts.
